(19) United States
(12) Patent Application Publication
(10) Pub. No.: US 2022/0169099 A1
(43) Pub. Date: Jun. 2, 2022

(54) Single Panel Roll-up Door

(71) Applicants: Jeff Phlipot, Sidney, OH (US); Mark Schneider, Sidney, OH (US); Larry Phlipot, Sidney, OH (US)

(72) Inventors: Jeff Phlipot, Sidney, OH (US); Mark Schneider, Sidney, OH (US); Larry Phlipot, Sidney, OH (US)

(21) Appl. No.: 17/676,144

(22) Filed: Feb. 19, 2022

Related U.S. Application Data
(60) Provisional application No. 63/254,662, filed on Oct. 12, 2021.

(51) Int. Cl. B60J 5/14; E06B 3/48; E06B 9/06; E06B 9/58

(52) U.S. Cl. CPC B60J 5/14; E06B 9/58; E06B 9/0638; E06B 3/485

(57) ABSTRACT

A single panel roll-up door comprising a panel, Roller brackets, rollers, a left roller series, a right roller series. Further the back side of the panel, wherein the surface of the back side of the panel comprising a first plateau, a first recessed channel, a plateau, a recessed channel, and a last recessed channel. Wherein the single panel roll-up door is coupled to a framed opening of a container, and the panel of the single panel roll-up door can be selectively in an opened position or closed position. When in the opened position the panel rest in the guide tracks in parallel.

### BACKGROUND

Various aspects of the present disclosure relate generally to a roll-up door, and specifically to a single panel roll-up door.

Tractor trailers, large containers, refrigerated containers, and the like normally have either one multi-panel roll-up door to secure the opening of the enclosure of the trailer; or contain a set of hinged doors; or contain a combination of the two sets of two doors having outside hinged doors and internal multi-panel roll-up door. The multi-panel roll-up door is prevalent in semi-truck trailers, storage containers, refrigerated trailers, garages, and aircrafts. The multi-panel roll-up door consist of multiple panels of corrugated metal, aluminum, or wood panels wherein the multiple individual panels are coupled together, by hinges, joints, or the like, to allow for the door to be lifted into an open position and lowered into a closed position.

There are two main types of multi-panel roll-up doors, multi-panel roll-up doors that roll upon itself on a drum and multi-panel roll-up doors that are coupled to guide tracks and follow the guide tracks along the ceiling of the container. Multi-panel roll-up doors that are on a drum although present the ease of use, reduce the internal clearing height of a trailer or container. Multi-panel roll-up doors that roll-up on guide tracks and rest flat against the ceiling provide better clearance but are heavy and can present a hazard when lowering.

In considerations for a tractor trailer roll-up door, and various implementations of a multi-panel roll-up doors, the door must be able to withstand the elements and abuse from heavy use. The multi-panel door has the structural integrity to withstand the opening and closing, assaults from forklifts, and the durability to withstand bumpy roads. Multi-panel roll doors are heavy and even the best multi-panel door still has seams that are susceptible to water intrusion. Multi-panel roll-up doors that have seals and joints to prevent water intrusion add to the overall weight of the roll-up door.

Therefore, a single panel roll-up door that is lighter than conventional roll-up doors, designed to withstand the elements, and eliminates water intrusion would be useful and advantageous.

### BRIEF SUMMARY

According to aspects of the present disclosure, a single panel roll-up door, coupled to a framed opening, the framed opening comprising a right side and a left side, of a container, the container comprising a floor and a ceiling; wherein the single panel roll-up door comprising a single solid panel, roller brackets, and rollers; wherein the single panel roll-up door rollers are coupled to the left and right guide tracks of the framed opening of the container; and wherein the single panel roll-up door can be selectively raised to an open position and selective lowered into a closed position.

The panel, of the single panel roll-up door, comprising a top edge of the panel, a bottom edge of the panel, a left edge of the panel, a right edge of the panel, a front side of the panel, and a back side of the panel. Wherein, the back side of the panel having a surface comprising a first plateau, a first recessed channel, a plateau, a recessed channel, and a last plateau. Wherein the first plateau comprising a top edge, a bottom edge, and a flat surface spanning an area longitudinal, from the left edge of the panel to the right edge of the panel, and perpendicular, from a top edge of the first plateau to the bottom edge of the first plateau, wherein the top edge of the first plateau meets with the top edge of the panel defining an edge therein. The first recessed channel, spanning longitudinal from the left edge of the panel to the right edge of the panel, comprising a top ridge of the first recessed channel, wherein the top ridge of the first recessed channel meets the bottom edge of the first plateau defining an edge therein. The plateau comprising a top edge of the plateau, a bottom edge of the plateau, and a flat surface spanning an area longitudinal, from the left edge of the panel to the right edge of the panel, and perpendicular, from a top edge of the plateau, wherein the top edge of the plateau meets with the bottom ridge of the first recessed channel, and the bottom edge of the plateau. The recessed channel, spanning longitudinal from the left edge of the panel to the right edge of the panel, comprising a top ridge of the recessed channel, wherein the top ridge of the recessed channel meets the bottom edge of the plateau, a bottom ridge of the recessed channel, and a channel of the recessed channel. The last plateau comprising a top edge of the last plateau, a bottom edge of the last plateau, and a flat surface of the last plateau, spanning an area longitudinal from the left edge of the panel to the right edge of the panel, and perpendicular, from a top edge of the last plateau, wherein the top edge of the last plateau meets the bottom ridge of the recessed channel, to the bottom edge of the last plateau, wherein the bottom edge of the last plateau meets the bottom edge the panel.

A left series of rollers, comprising rollers and roller brackets, are coupled to the left edge of the panel. The left series of rollers are coupled to the left edge of the panel and are coupled to the left guide track. Wherein the left series of rollers coupled to the left edge of the panel and coupled to the left guide track in a manner that allows the rollers to freely roll along the left guide track. The left guide track is coupled to the left series of rollers and coupled to the left side of the framed opening of the container.

The right series of rollers, comprising rollers and roller brackets, coupled to the right edge the panel. The right series of rollers coupled to the right edge of the panel are coupled to the right guide track. Wherein the right series of rollers coupled to the right edge of the panel and coupled to the right guide track in a manner that allows the rollers to freely roll along the right guide track. The right guide track being coupled to the right side of the framed opening of the container.

Wherein the left series of rollers move in the left guide track and the right series of rollers move in the right guide track, allowing the panel to be lifted in the opened position and lowered to the closed position. The left series and right series of rollers respectively traversing the left and right guide tracks. The course of the left and right guide tracks extending vertically form the floor of the container, the left guide track on the left side of the framed opening of the container and the right guide track on the right side of the framed opening of the container, to the ceiling of the container. When approaching the ceiling of the container, the guide tracks, bend at an arched angle back into the container following the course of direction of the ceiling into the container, allowing the panel, the left series of rollers and right series of rollers when in the opened position to rest in the guide tracks parallel in relation to the ceiling. Alternatively, when the panel is resting in the closed position the panel, the left series of rollers and the right series of rollers are perpendicular in relation to the ceiling and the floor of the container.

### BRIEF DESCRIPTION OF THE SEVERAL VIEWS OF DRAWINGS

FIG. 1 is a perspective view of a framed opening of a container, such as a container trailer for a semi-truck.

FIG. 2 is perspective view of a framed opening of a container, such as a container trailer for a semi-truck, illustrating the left and right guide tracks, the right roller series, rollers, and the panel resting in the opened state parallel to the ceiling of the container.

FIG. 3 is a view from the front of the panel, illustrating the front side of the panel, the top and bottom edges the panel, and the left and right edges of the panel.

FIG. 4 is a view from the back side of the panel, depicting the first plateau, showing the top edge of the first plateau correlating to the to edge of the panel, the first recessed channel, the first recessed channel, the plateau, the recessed channel, the left and right series of rollers, the roller brackets, and the last plateau, having a bottom edge of the last plateau correlating to the bottom edge of the panel.

FIG. 5 is a view from the rear of the container, as illustrated a container trailer, showing the panel resting in the closed position within the framed opening of the container, and the locking mechanism selectively locked to the floor of the container.

FIG. 6 is a close up enlarge view of the back side of the panel illustrating the alternating series of plateaus and recessed channels, the rollers, the roller brackets, the edge stiffener, wherein the rollers, roller brackets, and edge stiffener are coupled to the plateau sections.

### DETAILED DESCRIPTION

Aspects of the present disclosure provide for single panel roll-up door. Wherein the single panel roll-up door comprises a panel, roller brackets, and rollers. Wherein single panel roll-up door can be installed into framed opening of a container, wherein the framed opening of the container has left and right guide tracks for rollers. Wherein the roller brackets are coupled to the rollers, wherein a series of roller brackets and rollers define roller series. Wherein the panel has a left roller series and a right roller series. Wherein the left roller series are couple to the left edge of the panel of the single panel roll-up door and right roller series are coupled to the right edge of single panel roll-up door. Wherein the left and right roller series of the single panel roll-up door are coupled respectively to the left and right guide tracks of the framed opening. Wherein the guide tracks of the framed opening ascend vertically toward the ceiling of the container, and upon approaching the ceiling of the container, the guide tracks bend back within the container and continue parallel to the ceiling of the container, within the container. Wherein the single panel roll-up door can be selectively in an opened position or closed position. When in the opened position the panel rest in the guide tracks in parallel to the ceiling of the container of the framed opening.

Aspects of the present disclosure provide for the single panel roll-up door, wherein the panel, of the single panel roll-up door, having a front side, a back side, a left edge, a right edge, a top edge and a back edge. Wherein the front side of the panel is a continuous smooth surface. Wherein the back side of the panel having a surface comprising a first plateau, a first recessed channel, a plateau, a recessed channel, and a last recessed channel. Aspect of the present disclosure provide for single panel roll-up door that replace conventional roll-up doors or the single panel roll-up door can be installed into new container builds.

Particularly, the single panel roll-up door as described herein can be configured to satisfy user-specified dimensions of the framed opening of a container. The user specific dimensions of the single panel roll-up door still allows the panel to be lighter than conventional roll up doors of the same dimensions. As well as the single panel roll-up door described herein, is a solid single panel, that is lighter than what is realized in conventional roll-up door technologies at comparable dimensions. In this regard, the single panel roll-up door describe herein is particularly well suited for applications for replacement of conventional roll-up doors and new installations of roll-up doors such as semi-trailer roll-up doors, container roll-up doors, storage container roll-up doors, refrigeration trailer roll-up doors, and the like.

Moreover, the single panel roll-up door described herein provides a single panel roll-up door with a front side, directed to the exterior of the container, comprising a continuous surface. The single panel roll-up door described herein is a single solid panel, and is suited to prevent moisture intrusion form the elements. For instance, in the application of a semi-truck trailer, the single panel roll-up door, described herein, provides a seamless door preventing any moisture and mold. A conventional semi-trailer roll-up door is composed of multiple individual panels that are coupled together to form the roll-up door, even the best coupling for the multiple individual panels still has seams or joints. However, the single panel roll-up door, described herein, is a solid seamless single panel.

Moreover, to attain the desired rigidity of the multiple panel roll-up door necessary for a typical semi-trailer to withstand the elements; conventional roll-up doors requires material that is of either wood, metal, or other material, or the combination of the like which are heavy. Comparatively, the single panel roll-up door described herein uses light-weight components but maintains the rigidity of industry standards of conventional roll-up doors with multiple panels.

Moreover, the single panel roll-up door described herein, having a rigid and durable integrity of a conventional roll-up door, still maintains a certain flexibility to withstand blunt force from the impact of a forklift. Conventional roll-up doors made of durable wood become damaged due to the lack of flexibility. The single panel roll-up described herein, has the flexibility to withstand blunt force. Thus, the single panel roll-up door described herein, would be suited for applications such as semi-trailers, and the single panel roll-up door described herein would be advantageous over conventional roll-up doors.

Moreover, the single panel roll-up door herein can be configured to satisfy user-specified dimensions and depths and still be able to traverse the angled bend of industry standard guide tracks for a conventional multiple-panel roll-up door. The single panel roll-up door describe herein maintains its rigidity as well as can withstand the elements, and being lightweight can be configured to be thicker than conventional materials used in the industry. As an example advantage of the panel of the single panel roll-up door described herein, with increased thickness the panel of the single panel roll-up door can provide certain advantages of insulation more than conventional multi-panel roll up doors.

Moreover, previous challenges of creating such a single panel roll-up door that is suitable for semi-tractor trailers have failed due to limitations of materials. Previous attempts at creating such a single panel roll-up door have failed due to the inability to traverse the traditional guide tracks for roll up doors. Another reason previous attempts at a single panel roll-up doors have failed due to the inability to over come the bending angle of the standard roll-up door guide tracks. Conventional materials lack the flexibility to be able to bend in order to be solid panel roll-up door. Conventional materials would need to be thin to achieve the flexibility the single panel roll-up door described herein has. Conventional materials needing to be thin would lose the durability, and would easily be penetrable; losing the benefits of security that conventional material maintain. Such conceptual attempts using conventional materials would leave material to thin leading to warping at the bend, or be such a material that could not withstand the harsh conditions from the wind and elements during travel. Such a thin material would not hold up the continual and constant use, and further would not hold up to the rough environment of over the road hauling. However, the panel of the single panel roll-up door described herein overcomes these obstacles as it can be configured to satisfy user-specified dimensions of height, width, and depth and still have the flexibility to traverse the angled bend of industry standard guide tracks for a conventional multiple-panel roll-up door. The panel of the single panel roll-up door describe herein maintains its rigidity as well as can withstand the elements, and being lightweight can be configured to be thicker. The panel of the single panel roll up door described herein, is composed of a material that is lightweight, rigid, flexible, and provides a security that is improved over conventional materials.

Moreover, multi-panel roll-up doors that are used typically have hinges or joints between panels to accommodate the bend of guide tracks. Such reasons are why conventional roll-up doors are made of multi-panels, often coupled together by hinges or joints, to allow for the roll up door to have both structural integrity and flexibility to traverse the angled guide tracks. However, the single panel roll-up door described herein overcomes the need to use a multi-panel jointed or hinged panels by having the flexibility to traverse the industry standard guide tracks without the need for hinged or jointed coupling and does not have multiple panels.

Moreover, the single panel roll-up door described herein is more cost efficient than conventional multi-panel roll-up doors, and can be utilized to replace conventional multi-panel roll-up doors. One example embodiment of the single panel roll-up door described herein can use the existing guide tracks of the existing multi-panel roll-up doors, and easily replace multi-panel roll-up doors.

Moreover, the single panel roll-up door described herein overcomes the limitations and shortcomings of the multi-panel roll-up door. In one aspect the single panel roll-up door maintains the ridged structure of the multi-panel roll up door without the need for multiple panels. In another aspect, the single panel roll-up door described herein achieves the flexibility of multi-panel roll-up door without having multiple panels that are coupled by hinges or joints.

Moreover, some over-the-road hauling trailers have converted to tarps instead of either multiple-panel-roll up doors or conventional two panel swinging doors. The benefit of tarps are that they are cheap and easy to replace, however they do not provide any security to the contents within the trailer. In contrast, the panel of the single panel roll-up door described herein has the cost benefits of tarps but maintains the rigid structure of multi-panel roll-up doors and improves security of the contents within the trailer. As the panel of the single panel roll-up door herein has the rigidity or a multiple-panel door but a higher flexibility rate, which would increase security of the contents of the trailer. Further, the panel of the single panel single roll-up door, described herein, is of a solid material that resist easy penetration comprising of material that maintains its structural integrity.

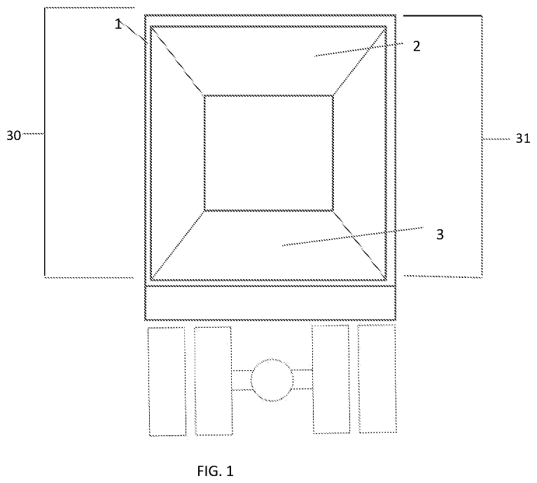

Referring now to the drawings, and in particular to FIG. 1 a perspective view of the framed opening of the container, such as a container trailer for a semi-truck. FIG. 1 depicts the framed opening 1 of the container in which the single panel roll-up would be coupled to. Wherein the framed opening of the container comprising a left side 30, a right side 31, a top and a bottom. Wherein the container comprising a ceiling 2, a floor 3, a left wall of the container, and a right wall of the container.

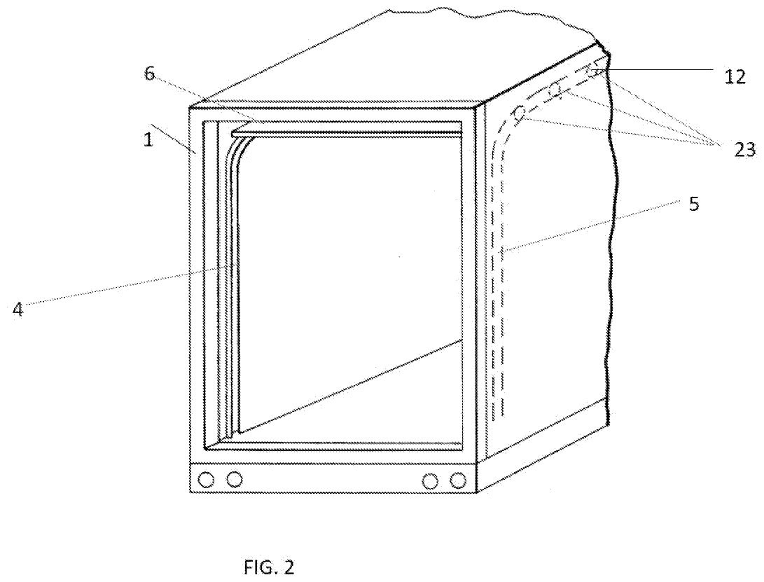

Referring to FIG. 2, a perspective view of a framed opening of a container, such as a container trailer for a semi-truck, illustrating the left guide track 4 of the framed opening of the container, and a cut away view of the right guide track 5 framed opening of the container. Wherein, the left 4 and right 5 guide tracks of the framed opening of the container being respectively coupled to the left 30 and right sides 31 of the framed opening; wherein the left guide track 4 of the framed opening is coupled to the left side of the framed opening 30 and right guide tracks coupled to the right side of the framed opening 31, ascend to the ceiling of the container 2 and arching back within in the container. Wherein the left 4 and right 5 guide tracks would also be coupled to the container ceiling 2 for the panel 6 to rest in the opened position in parallel in relation to the container ceiling 2.

Wherein, the left guide track 4 are coupled to a left series of rollers 22 and the right guide tracks 5 are coupled to a right series of rollers 23. Wherein, the left series of rollers 22 coupled to the left edge of the panel 7 and the right series of rollers 23 are coupled to the right edge 9 of the panel 9. FIG. 2 illustrating a cut away view of the right guide track 5, with a view of the right series of rollers 23 within the right guide track 5 of the framed opening, the panel 6, and an indication of the rollers 12 of the right series of rollers 23. FIG. 2 depicts the single panel roll-up door installed within the framed opening of a container. FIG. 2 depicts the panel 6, coupled to the left 22 and right 23 roller series, wherein the left 22 and right 23 roller series are respectively coupled to the left 4 and right 5 guide tracks, wherein the left 4 and right 5 guide tracks are respectively coupled to the left 30 and right 31 sides of the framed opening. Wherein, the left 4 and right 5 guide tracks coupled respectively to the left 30 and right 31 sides of the framed opening ascend to the container ceiling and bend at an arch to continue along the ceiling 2 parallel with ceiling of the container. Wherein the panel 6, when resting in an opened position, rest parallel with the ceiling of the container 2. The single panel roll-up door having a panel 6 that is coupled to the left series of rollers 22, coupled to the left edge 9 of the panel, wherein the left series of rollers 22 are coupled to the left guide track 4, wherein the left guide track 4 is coupled to the left side 30 of the framed opening of the container and the ceiling of the contrainer. Wherein the right series of rollers 23 coupled to the right edge 7 of the panel, and the right series of rollers 23 are coupled to the right guide track 5, and the right guide track 5 is coupled to the right side 31 of the framed opening and coupled to the ceiling of the container 2. Wherein, the left series 22 of rollers and the right series of rollers 23 are respectively coupled to the left 4 and right 5 guide tracks in a fashion that the coupling allows for the panel 6 of the single panel roll-up to be selectively raised and lowered.

FIG. 2 also illustrates another embodiment of the single panel roll-up door that could be installed as a replacement to a conventional multi-panel roll-up door within a container that has previously installed left 4 and right 5 guide tracks. Wherein the single panel roll-up door could be configured to be installed utilizing the existing guide tracks.

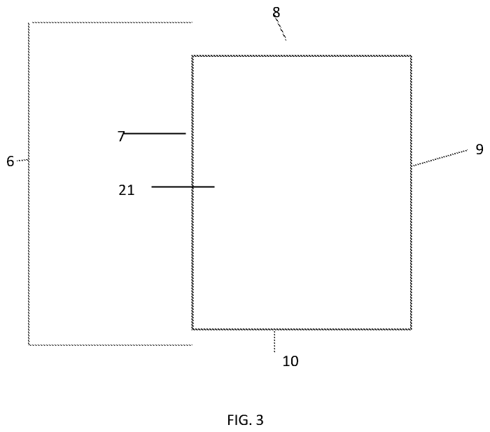

Referring to FIG. 3, a view from the front side 21 of the panel 6, illustrating the front side of the panel 21, the top edge of the panel 8, the bottom edge of the panel 10, the left edge of the panel 7, and the right edge of the panel 7. FIG. 3 illustrates the smooth continuous surface of the font side of the panel 21. Additional, FIG. 3 depicts that front of the panel 21, as a solid single panel.

FIG. 3 also illustrates another embodiment of the single panel roll-up door wherein the panel 6 comprises a thermoplastic composite. In another embodiment of the single panel roll-up door, the panel 6 comprises a multi-layer thermoplastic fibrous composite. Thermoplastic composites and multi-layer thermoplastic fibrous composites are well known in the industry, however, the innovation in utilizing such a material as a thermoplastic composite or a multi-layer thermoplastic fibrous composite as in described the single panel roll-up door herein are novel. In another embodiment of the single panel roll-up door certain aspects of the thermoplastic composite or multi-layer thermoplastic fibrous composite create the panel, wherein the panel could be comprised of fibrous material such as multi-layer fiber reinforced thermoplastic, fibrous material of glass, fibrous material of plastic, fibrous material of resin, fibrous material of fiberglass, or a combination thereof.

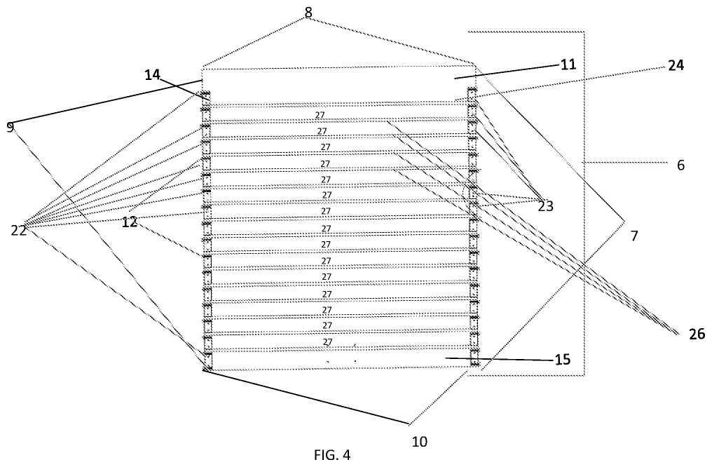

Referring to FIG. 4, a view from the back side of the panel 6, comprising a surface of a first plateau 11, a first recessed channel 24, a plateau 27, a recessed channel 28, a last plateau 25, a left series of rollers 22, and a right series of rollers 23.

Wherein the first plateau 11, comprises a top edge of the first plateau; a bottom edge of the first plateau; and a flat surface of the first plateau, spanning an area perpendicular from the top edge of the panel 8 to the bottom edge of the first plateau, and longitudinal from the left edge 9 of the panel 6 to the right edge 7 of the panel 6. Wherein the top edge of the first plateau 11 meets to the top edge 8 of the panel 6 defining an edge between the top edge of the first plateau and the top edge of the panel 8 and the bottom edge of the first plateau 24.

Wherein the first recessed channel 24, spanning longitudinal from the left edge of the panel to the right edge of the panel, comprising a top ridge of the first recessed channel and a bottom ridge of the first recessed channel, and a channel of the first recessed channel. Wherein the top ridge of the first recessed channel 24 meets the bottom edge of the first plateau 11 defining an edge line between the top ridge of the recessed channel and the bottom edge of the first plateau 11. Wherein the bottom ridge of the the first recessed channel meets the top edged of the plateau 27. Wherein a space is defined between the top ridge of the recessed channel and the bottom ridge of the recessed channel, wherein the space creates the channel, and defining a corridor which of the first recessed channel. Wherein the channel of the first recessed channel is a grooved section, grooved into the back side of the panel with a depth not to exceed the thickness of the panel, and therein a channel is defined between the top ridge of the first recessed channel and the bottom ridge of the first recessed channel;

Wherein the plateau 27, a flat surface spanning an area perpendicular form the bottom ridge of the first recessed channel and longitudinal from the left edge 9 of the panel 6 to the right edge 7 of the panel 6. Wherein the plateau comprises a top edge of the plateau and a bottom edge of the plateau. Wherein the top edge of the plateau 27 meets with the bottom ridge of the first recessed channel 24 and defines an edge between the bottom ridge of the first recessed channel and the top edge of the plateau.

Wherein the recessed channel, spanning longitudinal from the left edge 9 of the panel 6 to the right edge 7 of the panel 6, comprising a top ridge of the recessed channel and bottom ridge of the recessed channel. Wherein the bottom edge of the plateau meets the top ridge the recessed channel 28, and defines and edge with the bottom edge of the plateau and the top ridge of the recessed channel. Wherein the recessed channel comprises; a top ridge of the recessed channel, wherein the top ridge of the recessed channel meets with the bottom edge of the plateau, defining an edge between the top ridge of the recessed channel and the bottom edge of the plateau; a bottom ridge of the recessed channel; and a channel of the recessed channel, wherein, the channel of the recessed channel is a grooved section, grooved into the back side of the panel with a depth not exceed the thickness of the panel, and therein a channel is defined between the top ridge of the recessed channel and the bottom ridge of the recessed channel, spanning longitudinal from the left edge of the panel to the right edge of the panel

Wherein the last plateau comprising a flat surface, spanning an area perpendicular, from the bottom edge of the recessed channel and bottom edge of the panel, and longitudinal, from the left edge 7 of the panel to the right edge 9 of the panel, comprising; a top edge of the last plateau 8, correlating to the bottom ridge of the recessed channel, and defining an edge between the bottom ridge of the recessed channel and the top edge of the last plateau; and a bottom edge of the last plateau 10, meet the bottom edge of panel 10 and defines an edge with the bottom edge of the last plateau and the bottom edge of the panel.

Wherein the left series of rollers 22, comprising rollers 12, coupled to the panel 6 on the left edge 9 of the panel. FIG. 4 depicts the left series of rollers 22 coupled to the back of the panel 6. The left series of rollers 22 that are coupled to the left edge 9 of the panel 6. The left edge of the left series of rollers 22 coupled to the left edge 9 of the panel are also coupled to the left guide track 4 in a manner that allows the rollers 12 to freely roll along the left guide track 4. The left guide track 4 is coupled to the left side of the framed opening of the container.

Wherein the right series of rollers 23 are coupled to the panel 6 on the right edge 7 of the panel. The right series of rollers 23 are coupled to the right edge 7 of the panel 6. FIG. 4 depicts the right series of rollers 23 coupled to the back of the panel. The right series of rollers 23 are also coupled to the right guide track 5 in a manner that allows the rollers to freely roll along the right guide track 4. The right guide track 4 is coupled to the right side of the framed opening of the container.

FIG. 4 depicts an embodiment of the single panel roll-up door wherein the left series of rollers 22 and the right series of rollers 23 are coupled to the back side of the panel. The left series of rollers 22 coupled to the left edge of the panel 9 on the back side of the panel, and the right series of rollers 23 are coupled to the right edge 7 of the panel 6. The left series of rollers 22 are coupled to the left guide track. The left guide track 4 is coupled to the left side of the framed opening of the container. The right series of roller 23 are coupled to the right guide track, wherein the right guide track 5 is coupled to the right side of the framed opening of the container.

FIG. 4 depicts another embodiment of the single panel roll-up door comprising a series alternating plateaus and recessed channels 26. Wherein the series of alternating plateaus and recessed channels 26 comprising a first plateau 11, a first recess channel 13, a plateau 27, a recess channel 28, a plateau, a recess channel and continuing in alternating series of plateaus 27, recess channels 28 until meeting the user-specific length including the last plateau.

Wherein a last recessed channel in the alternating series of plateaus and recess channels meets the last plateau of the panel 15.

Wherein the last plateau comprising; a top edge of the last plateau, meeting the bottom ridge of the last recessed channel, and a bottom edge of the last plateau 15, correlating to the bottom edge of panel 10.

Wherein the top edge of the last plateau 15, would correlate with the bottom ridge of the last recess channel in the alternating series of plateaus 27 and recess channels 28 being determined by the dimensional length being user-specified in which the panel 6, in the closed position, close the opening of the framed container.

FIG. 4 depicts another embodiment of the single panel roll-up door comprising rollers 12 that are coupled to the panel 6 by a roller bracket 14. Wherein the roller 12 and the roller bracket 14 coupled to the backside of the panel in location to the first plateaus 11, the plateaus 27, and last plateau. Wherein the individual roller brackets comprise a coupling individually and respectively with the top and bottom edges of the first plateau, or plateaus, or the last plateau in relation to where each individual roller bracket is mounted relation to the first plateau, or the plateaus, or the last plateau. The roller bracket that is coupled to the first plateau, is coupled in such a manner that the roller bracket strengthens the top and bottom edges of the first plateau, or the top and bottom edges the plateaus, or the top and bottom edges of last plateau.

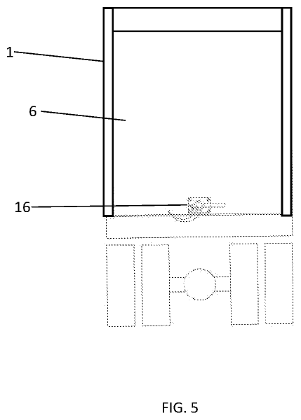

Referring to FIG. 5, a view from the rear of the container, as depicting an embodiment of the single panel roll-up door mounted within a container trailer, showing the panel 6 resting in the closed position within the framed opening 1 of the container.

FIG. 5 depicts an additional embodiment of the single panel roll-up door in comprising a locking mechanism 16. Wherein the locking mechanism 16 is coupled to the last plateau and allows the panel to be selectively locked to the floor of the container.

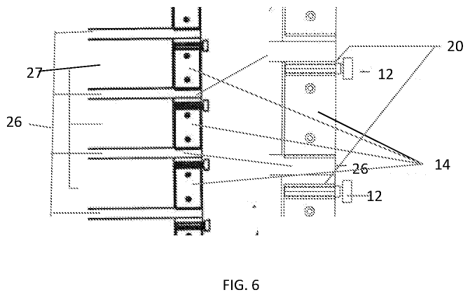

Referring to FIG. 6, is a close up enlarged view of the back side of the panel depicting an additional embodiment of the coupling of the rollers 12 to the panel 6. FIG. 6 illustrates the plateaus 27 and recessed channels 13, the rollers 12, the roller brackets 14, the edge stiffener 20, wherein the rollers 12, roller brackets 14, and edge stiffener 20 are coupled to the plateau 27. FIG. 6 illustrates the plateaus 27 and the recess channels 13, represent the alternating plateaus and recess channels 26 without the first plateau and the last plateau due to the close up view. Section

One embodiment of the single panel roll-up door is in which the panel 6 comprises a thermoplastic composite material. In another embodiment of the single panel roll-up door, the panel 6 comprises a multi-layer thermoplastic fibrous composite. In yet another embodiment of the single panel roll-up door is in which the panel 6 comprises light weight wood bi-product.

In an example implementation of the single panel roll-up door, the panel 6 has a length of one-hundred and eleven inches and a width of one-hundred inches. In another example implementation of the single panel roll-up door, the panel 6 has length as described by user specific needs and a width as described by user specific needs. In yet another example implementation of the single panel roll-up door, the panel 6 has a length of seventy two inches and a width of forty eight inches.

In an example implementation of the single panel roll-up door, the panel 6 has a thickness of up to ⅝ths of an inch. In another example implementation single panel roll-up door, the panel 6 has a thickness that may exceed one inch. In yet another example implementation of the single panel roll-up door, the panel 6 has a thickness of one fourth (¼) of an inch. In yet another example implementation of the single panel roll-up door, the panel 6 has a thickness that can be specified by the user specified needs.

In an example implementation of the single panel roll-up door, the first plateau 11, a flat surface spanning an area perpendicular, from the top edge of the panel 8 to a bottom edge of the first plateau, and longitudinal from the left edge 9 of the panel 6 to the right edge 7 of the panel 6, comprising a top edge of the first plateau and the bottom edge of the first plateau; wherein the top edge of the first plateau 11 meets to the top edge 8 of the panel 6 defining an edge between the top edge of the first plateau and the top edge of the panel 8 and the bottom edge of the first plateau 24. The bottom edge of the first plateau meets with and wherein the distance between the top edge of the first plateau and the bottom edge for the first plateau 24 is a distance up to thirteen inches. In another example implementation of the single panel roll-up door, the first plateau wherein the distance between the top edge of the first plateau and the bottom edge of the first plateau 24 may have a distance that is less than thirteen inches. In yet another example implementation of the single panel roll-up door, the first plateau may have a distance between the top edge of the first plateau and the bottom edge of the first plateau 24 more than thirteen inches, dependent on user specific needs.

In an example implementation of the single panel roll-up door, wherein the first recessed channel 24, spanning longitudinal from the left edge of the panel to the right edge of the panel, comprising a top ridge of the first recessed channel and a bottom ridge of the first recessed channel; wherein the top ridge of the first recessed channel 24 meets the bottom edge of the first plateau 11 defining an edge line between the top ridge of the recessed channel and the bottom edge of the first plateau 11; wherein a space is defined between the top ridge of the recessed channel and the bottom ridge of the recessed channel; wherein the space creates the corridor if the first recessed channel; wherein the space between the top ridge of the recessed channel and the bottom ridge of the recessed channel up to one inch in distance. In another example implementation of the single panel roll-up door, wherein the space between the top ridge of the recessed channel and the bottom ridge of the recessed channel may exceed one inch. In yet another example implementation of the single panel roll-up door, wherein the space between the top ridge of the recessed channel and the bottom ridge of the recessed channel may be defined as to user specific needs.

The terminology used herein is for the purpose of describing particular embodiments only and is not intended to be limiting for the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed:

1. A single panel roll-up door comprising a panel, roller brackets, and rollers, wherein the single panel roll-up door is installed into a framed opening of a container; wherein the panel of the single panel roll-up door comprises:
a solid panel comprising a multi-layer thermoplastic fibrous composite wherein the panel comprises:
a top edge of the panel; and
a bottom edge of the panel; and
a left edge of the panel; and
a right edge of the panel; and
a front side of the panel; wherein the front side of the panel is a continuous surface; and
a back side of the panel;
wherein the back side of the panel having a surface comprising a first plateau, a first recessed channel, a plateau, a recessed channel, and a last plateau;
wherein the first plateau comprising a top edge of the first plateau, a bottom edge of the first plateau, and a flat surface of the first plateau; wherein the flat surface of the first plateau spanning an area perpendicular from the top edge of the panel to the bottom edge of the first plateau, and spanning an area longitudinal from the left edge of the panel to the right edge of the panel; wherein the top edge of the first plateau meets with the top edge of the panel defining an edge therein; and
wherein the first recessed channel, spanning longitudinal from the left edge of the panel to the right edge of the panel, comprises a top ridge of the first recessed channel, a channel of the first recessed channel, and a bottom ridge of the first recessed channel;
wherein the bottom edge of the first plateau meets with the top ridge of the first recessed channel, defining an edge therein with the bottom edge of the first plateau and the top ridge of the first recessed channel,
wherein the channel of the first recessed channel is a grooved section, grooved into the back side of the panel with a depth not to exceed the thickness of the panel, and therein a channel is defined between the top ridge of the first recessed channel and the bottom ridge of the first recessed channel;
wherein the plateau comprises a top edge of the plateau, a bottom edge of the plateau, and a flat surface of the plateau;
wherein, the top edge of the plateau meets with the bottom ridge of the first recessed channel defining an edge therein;
wherein the flat surface of the plateau spans an area perpendicular, from the top edge of the plateau to the bottom edge of the plateau, and longitudinal, from the left edge of the panel to the right edge of the panel; and
wherein the recessed channel comprises; a top ridge of the recessed channel, wherein the top ridge of the recessed channel meets with the bottom edge of the plateau, defining an edge between the top ridge of the recessed channel and the bottom edge of the plateau; a bottom ridge of the recessed channel; and a channel of the recessed channel, wherein, the channel of the recessed channel is a grooved section, grooved into the back side of the panel with a depth not exceed the thickness of the panel, and therein a channel is defined between the top ridge of the recessed channel and the bottom ridge of the recessed channel, spanning longitudinal from the left edge of the panel to the right edge of the panel; and
wherein the last plateau comprises: a top edge of the last plateau, wherein the top edge of the last plateau meets with the bottom ridge of the recessed channel defining and edge therein; a bottom edge of the last plateau, wherein the bottom edge of the last plateau meets with the bottom edge of the panel and defines an edge therein; and the flat surface of the last plateau; wherein the flat surface of the last plateau spans an area perpendicular from the first edge of the last plateau and the bottom edge of the last plateau, and spanning an area longitudinal from the left edge of the panel to the right edge of the panel;
wherein roller brackets are coupled to the left edge of the panel, wherein rollers are coupled to the roller brackets that are coupled to the left edge of the panel; wherein the roller brackets and the rollers coupled to the left edge of the panel define a left series of rollers; wherein the left series of rollers are coupled to the left guide track of the framed opening; and
wherein roller brackets are coupled to the right edge of the panel, wherein rollers are coupled to the roller brackets that are coupled to the right edge of the panel; wherein the roller brackets and the rollers coupled to the right edge of the panel define a right series of rollers; wherein the right series of rollers are coupled to the right guide track of the framed opening;
wherein right series of rollers and the left series of rollers allow the single panel roll-up door to move along the guide tracks, wherein the single panel roll-up door can be selective opened and closed; wherein the single panel roll-up door when in the open position rest in the guide tracks in parallel to the ceiling of the container,

2. The single panel roll up door of claim 1, wherein the panel is comprised of a thermoplastic composite.

3. The single panel roll up door of claim 1 or 2, wherein the panel dimensions, width of the panel, thickness of the panel, and length of the panel are specified by user specific dimension of the framed opening of the container; wherein the back of the panel comprises a first plateau, a first recessed channel, and alternating series of plateaus and recessed channels, depending on user specific length, and a last plateau.

4. The single panel roll-up door of claim 1, 2, or 3, wherein the panel is coupled to a locking mechanism, and the locking mechanism is coupled to the bottom edge of the panel adapted to be selectively coupled to the floor of the container to lock the roll-up door in the closed position.

5. The single panel roll-up door of claim 1, 2, or 3 wherein the top edge of the panel is reinforced by a strengthening strip, the bottom edge of the panel is reinforced by a second strengthening strip, the right edge of the panel is reinforced by a third strengthening strip, and the left edge of the panel is reinforced by a fourth strengthening strip.

6. The single panel roll-up door of claim 1, 2, or 3 wherein the left series of rollers, comprising rollers, and the right series of rollers, comprising rollers are coupled to the back side of the panel with roller brackets; wherein, the roller brackets are coupled respectively to the left and right edges of the panel coupled to the portions of the back side of the panel designated as first plateau, plateau, and last plateau; wherein, the roller brackets are coupled with the top and bottom edges of the first plateau, the top and bottom edges of plateau, and top and bottom edges of the last plateau in a manner that strengthens the top and bottom edges of the first plateau, the plateaus, and the last plateau.

7. The single panel roll-up door of claim 1, 2, or 3 wherein the left series of rollers, comprising rollers and roller brackets, and the right series of rollers, comprising rollers and roller brackets, wherein the left and right series of rollers are respectively coupled to in a manner that allows the rollers to freely roll along the right the left and right guide tracks of the framed opening in manner that allows the single panel roll-up door to have a selective opened position and selective closed position; wherein in the selective open position the single panel roll-up door traverses the guide tracks extending vertically form the floor of the container, the left guide track on the left side of the framed opening of the container and the right guide track on the right side of the framed opening of the container, to the ceiling of the container, approaching the ceiling of the container; wherein the guide tracks, approaching the container ceiling, bend at an arched angle back into the container following the course of direction of the ceiling into the container, allowing the panel in the opened position to rest, within the container, in the guide tracks parallel in relation to the ceiling, and alternatively when the panel is resting in the closed position to be perpendicular in relation to the ceiling and the floor of the container.
